(19) United States
(12) Patent Application Publication
(10) Pub. No.: US 2017/0047746 A1
(43) Pub. Date: Feb. 16, 2017

(54) OPTIMIZED ENERGY TRANSFER ALGORITHM FOR ENERGY STORAGE ARRANGEMENT

(71) Applicant: SCHOELLER LOGISTICS TECHNOLOGIES HOLDING GMBH, Pullach (DE)

(72) Inventors: Thomas BLOCHBERGER, Wien (AT); Hans HARJUNG, Wien (AT)

(73) Assignee: SCHOELLER LOGISTICS TECHNOLOGIES HOLDING GMBH, Pullach (DE)

(21) Appl. No.: 15/306,426

(22) PCT Filed: Apr. 24, 2015
(86) PCT No.: PCT/EP2015/058935

§ 371 Date: Oct. 24, 2016

(30) Foreign Application Priority Data
Apr. 24, 2014 (AT) A 294/2014

(51) Int. Cl. H02J 7/00

(52) U.S. Cl. CPC H02J 7/0013; H02J 7/0021

(57) ABSTRACT

The method for operating an energy storage arrangement with a plurality of serially connected storage cells according to the present invention comprising following steps: Calculating the amount of energy to be transferred so that all cells reach a predetermined state-of-charge and calculating the energy losses in the energy transfer units. Determining the load profile and calculating the remaining time (t_{Transfer}, t′_{Transfer}) until the energy storage arrangement reaches the predetermined state-of-charge. Calculating the energy transfer unit's power capability (P_{iTransfer}, P′_{iTransfer}) at the selected range of operation. Calculating the amount of energy to be transferred from/to each individual cell (E_{iTransfer}, E′_{iTransfer}) Calculating the individual state-of-charge (SoC_{IA}, SoC_{IE}) point for each cell at which the energy transfer among individual cells must be activated to reach predetermined individual state-of-charge at the same time.

The invention relates to a method for operating an energy storage arrangement.

Electrical energy stores, for example for electric vehicles, generally comprise high-power rechargeable batteries, which comprise a large number of galvanic cells connected to one another in order thus to meet the requirements placed on the energy store as regards supply voltage, power and capacity.

Such an interconnection of cells is also referred to as a battery system or rechargeable battery pack.

Various electrochemical methods which are named referring to materials used are available as the technological basis for the galvanic cells. These include nickel-metal hydride (NiMH), lead add (PbA) and especially all variations of lithium chemistry technologies (e.g. NMC, LFP, LiPo, Li—Si, Li-Air).

A common feature to all available technologies is that cells which are identical per se with the same operating age have slightly different properties, for example owing to production tolerances, temperature influences or mechanical influences.

As a result, they have different charge and discharge characteristics, which means that individual cells are subject to a greater load and are therefore destroyed prematurely, as a result of which the entire rechargeable battery then fails.

The properties of galvanic cells also change over the course of their existence. This change is dependent on many influencing factors and takes place irrespective of whether the cell is in the quiescent state, or is being discharged or charged.

The extent of the change is dependent on the nature, size and the combined effect of the influencing factors and on the temporal duration of this change.

When connecting galvanic cells to one another to form a storage arrangement, the performance of the entire arrangement is critically determined by the weakest cells, i.e. the cells with the comparatively lowest performance. Without any control interventions, these weakest cells are the first to reach their end-of-charge voltage during a charge operation and to reach the end-of-discharge voltage during a discharge operation and thus limit the usable capacity of the entire rechargeable battery arrangement.

In order to avoid the described problems, it is known to produce, where possible, cells with equaling properties, but this is subject to physical and economic limits. In addition to this, therefore, after production the cells are measured individually in accordance with specific properties usually capacity and internal resistance, and sorted into groups such that in each case cells with very similar properties, i.e. properties which are within a narrow tolerance range, are used for one arrangement. This operation is referred to as “matching”.

The process is complex and accounts for approximately 10% of the manufacturing costs of a rechargeable battery pack. However, this expenditure does not prevent cell drift, but merely delays it and therefore extends the life of the rechargeable battery pack slightly.

Recent battery systems are moreover controlled by battery management systems which monitor the cells and regulate the charge or discharge current. In this case, a distinction is drawn between passive and active balancing.

In the case of passive balancing, a switchable load resistance is connected in parallel with each battery cell. During charging, this load resistance is switched on when a predetermined end-of-charge voltage is reached, and therefore the current is guided past the battery cell in question. The charge operation is continued until all of the cells in the battery system have reached the predetermined end-of-charge voltage.

In a discharge operation, the predetermined end-of-discharge voltage of the cells is monitored, and the discharge operation is terminated when this voltage through the first (weakest) cell has been reached. The stronger cells at this time still have residual energy, but this cannot be used in systems with passive balancing.

In the case of so-called active balancing methods, a switchable voltage transformer is used in place of a load resistance, said voltage transformer having the capacity to transfer the energy to be guided past a cell into an adjacent cell, for example, or a cell group. As a result, in contrast to the passive balancing methods, the excess energy is returned to the system and is not converted into heat.

The common aim of the known methods is always to avoid overloading individual cells and therefore prevent an excessive reduction in the life, whilst taking into consideration charge/discharge current intensity, end-of-charge voltage and depth of discharge.

These methods of passive and active balancing are state of the art. The invention goes beyond these two methods.

The method for operating an energy storage arrangement with a plurality of serially connected storage cells according to the present invention comprising following steps: Calculating the amount of energy to be transferred so that all cells reach a predetermined state-of-charge and calculating the energy losses in the energy transfer units. Determining the load profile and calculating the remaining time (t_{Transfer}, t′_{Transfer}) until the energy storage arrangement reaches the predetermined state-of-charge. Calculating the energy transfer unit's power capability (P_{iTransfer}, P′_{iTransfer}) at the selected range of operation. Calculating the amount of energy to be transferred front/to each individual cell (E_{iTransfer}, E′_{iTransfer}). Calculating the individual state-of-charge (SoC_{IA}, SoC_{IE}) point for each cell at which the energy transfer among individual cells must be activated to reach predetermined individual state-of-charge at the same time.

The predetermined individual state-of-charge is preferably an equal predetermined state-of-charge for all cells. The predetermined individual state-of-charge is further preferably when the end-of-charge voltage (CVL) or the end-of-discharge voltage (DVL) is reached. Alternatively, the predetermined individual state-of-charge may be any state-of-charge between 0% and 100%.

An advantage of the method according the present is that SoC for individual cells in the energy storage arrangement does not have to be balanced actively during the whole charge/discharge process but only when it is needed, e.g. when the energy storage arrangement is charged/discharged completely to end-of-charge voltage (CVL) or the end-of-discharge voltage (DVL).

According to the invention, the charge and discharge operations of the individual cells in a battery system are configured such that over the different aging process of the individual cells in the group, the cells adjust such that their properties are harmonized over the course of time.

The aging process of the individual cells is in this case controlled via spending, cell-individual limit values for aging-influencing cell parameters.

Thus, for example, a cell ages considerably slower when it is charged during the charge operations in each case only to 95%, instead of to the full, predetermined end-of-charge voltage.

Precisely the end-of-charge voltage represents a considerable stress factor, especially for Li-ion cells with virtually any chemistry. In particular in the case of electric vehicles, the battery system is usually charged to the maximum capacity (i.e. the respective cell voltage is at the level of the end-of-charge voltage) since, where possible, it is desirable to always have the full operating range available owing to the limited operating range in the case of electric vehicles.

Essential further influencing factors on the change in the cell properties and therefore the aging of the cells are as follows: storage voltage, operating voltage, charge and discharge current intensity, state of charge, level of defined end-of-charge and end-of-discharge voltage, calendrical age of the cell, number of previous charge and discharge cycles, speed of charge/discharge changeovers and temperature during all quiescent and operating states, i.e. during storage, in the quiescent state, during charging and during discharging. The temporal duration for which one or more of the influencing factors take effect also substantially influences the cell properties.

The invention will be explained in more detail with reference to an exemplary method illustrated in the figures, as examples:

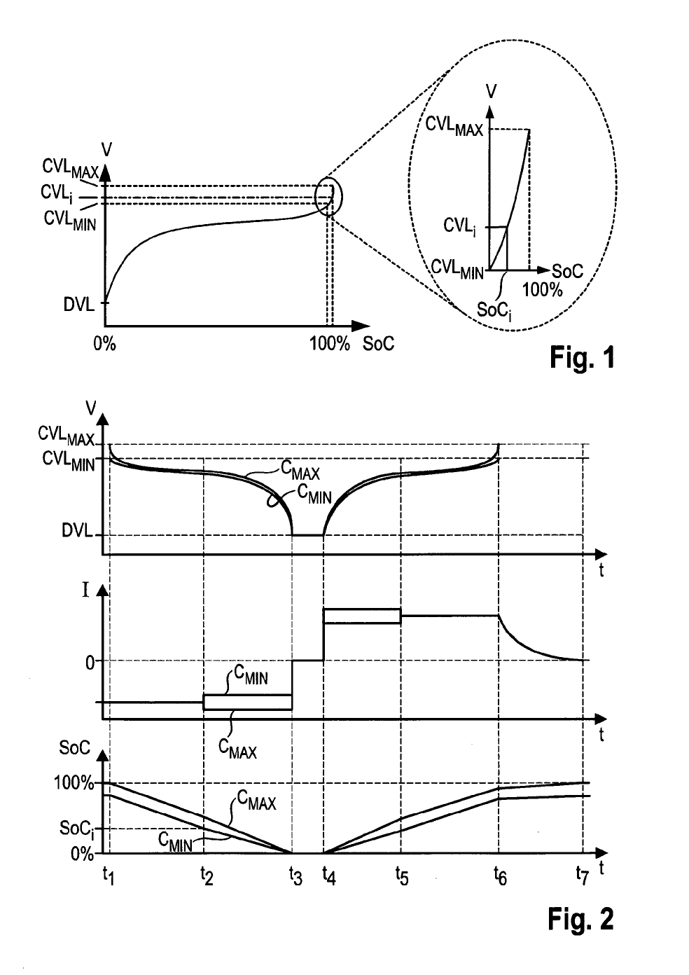

FIG. 1 shows the ratio of charge voltage to state of charge in a typical cell in an energy storage arrangement,

FIG. 2 shows the profiles of charge voltage, current and state of charge in typical charge and discharge operations,

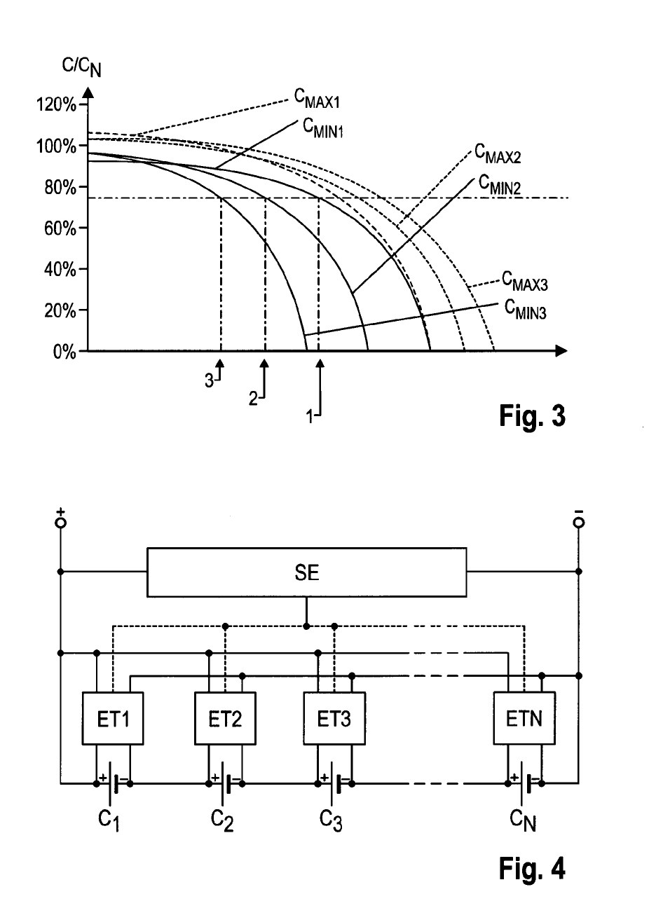

FIG. 3 shows a comparison of the aging processes of cells when using various battery management methods,

FIG. 4 shows an arrangement for implementing the methods.

The exemplary method comprises three subprocesses: an initialization process, an operating process and at least one calibration process.

The initialization process is performed when the storage arrangement is first brought into operation. It serves the purpose of precisely detecting the different properties of the individual cells in the storage arrangement and then deriving the bases for the further control method from these properties.

In this case, first all of the cells in the storage arrangement are charged completely, i.e. in each case until the end-of-charge voltage CVL predetermined by the manufacturer is reached. Then, the storage arrangement is completely discharged, with the result that each individual cell reaches the end-of-discharge voltage DVL predetermined by the manufacturer.

For this purpose, for example during discharge, all of the cells are discharged with a constant, equal absolute current value until a first cell has reached the end-of-discharge voltage DVL.

Then, this first cell is not loaded any further, i.e. the further current flow is guided past said cell by means of the energy transfer units in a battery management system, as is described in WO 2010/088944, for example.

The discharge operation is continued in this way until a second cell has also reached the end-of-discharge voltage DVL. This cell is also not loaded any further and the discharge operation is only continued with the cells which have not yet reached their end-of-discharge voltage DVL. This continues until all of the cells have been discharged, i.e. until the end-of-discharge voltage DVL predetermined by the manufacturer has been reached.

During the discharge operation, the total current and the individual currents guided past the respective cell are measured. From this, the critical properties of the cells, such as the cell capacity, the internal resistance and so-called state-of-health parameters (SOH), are determined.

These data form the basis for the determination of cell-individual regulation parameters and their limit values.

This will be described below using the example of the end-of-charge voltage CVL in a possible variant for a storage arrangement comprising 5 cells connected in series:

The determined cell capacities are illustrated in Table 1:

TABLE 1

| | Cell1 | Cell2 | Cell3 | Cell4 | Cell5 |
|---|---|---|---|---|---|
| Capacity Cᵢ | 50 Ah | 51 Ah | 49 Ah | 48 Ah | 52 Ah |

The greatest capacity C_{MAX} is defined as reference capacity C_{REF}:

C_{REF}=C_{MAX}

Then, the cells are classified and ordered in accordance with their capacities Cᵢ or the difference in the individual cell capacity ΔCᵢ with respect to the reference capacity ΔCᵢ=C_{REF}−Cᵢ, as illustrated in Table 2:

TABLE 2

| Ordering | Cell5 | | Cell2 | | Cell1 | | Cell3 | | Cell4 | |
|---|---|---|---|---|---|---|---|---|---|---|
| Capacity Cᵢ | 52 | Ah | 51 | Ah | 50 | Ah | 49 | Ah | 48 | Ah |
| Difference in | 0 | Ah | 1 | Ah | 2 | Ah | 3 | Ah | 4 | Ah |
| capacity ΔCᵢ | | | | | | | | | | |

The end-of-charge voltage CVL predetermined by the manufacturer is set as maximum end-of-charge voltage CVL_{MAX}.

Conservation of the weaker cells is achieved according to the invention by a cell-individual reduction in the end-of-charge voltage CVLᵢ in accordance with

CVLᵢ=f_{CVL}(ΔCᵢ).

The relationship function f_{CVL} is derived in the exemplary embodiment from the open circuit voltage characteristic OCV predetermined by the manufacturer for the cells, as is illustrated in FIG. 1.

In this case, it is advantageous lithe minimum end-of-charge voltage CVL_{MIN}, i.e. the end-of-charge voltage of the weakest cell, is still fixed in the steep end section of the open circuit voltage characteristic OCV.

The cell-individual end-of-charge voltages CVLᵢ of the remaining cells are then distributed between CVL_{MAX} and CVL_{MIN} in accordance with the ordering of the calls using the differences in capacity. This distribution can in the simplest case take place linearly, but also with any other desired form (for example exponentially, logarithmically).

As a variant, the absolute values of the cell-individual end-of-charge voltage CVLᵢ can also be fixed in such a way that only a group of the weaker cells, for example half of them, are given an end-of-charge voltage CVLᵢ which is reduced individually in accordance with their ordering and all of the other cells are given the end-of-charge voltage CVL predetermined by the manufacturer. Thus, the reduction in capacity as a result of a reduced end-of-charge voltage CVLᵢ is less.

Assuming that the end-of-charge voltage CVL predetermined by the manufacturer is 4.2 V and the gradient of the open circuit voltage characteristic OCV reaches a value of 100% at a cell voltage of 4.0 V and the cell-individual end-of-charge voltage CVLᵢ is distributed linearly, the cell-individual end-of-charge voltages CVLᵢ shown in Table 3 result:

TABLE 3

| Ordering | Cell5 | | Cell2 | | Cell1 | | Cell3 | | Cell4 | |
|---|---|---|---|---|---|---|---|---|---|---|
| Capacity Cᵢ | 52 | Ah | 51 | Ah | 50 | Ah | 49 | Ah | 48 | Ah |
| Difference in | 0 | Ah | 1 | Ah | 2 | Ah | 3 | Ah | 4 | Ah |
| capacity ΔCᵢ | | | | | | | | | | |
| CVLᵢ | 4.2 | V | 4.15 | V | 4.1 | V | 4.05 | V | 4.0 | V |

Once cell-individual end-of-charge voltages CVLᵢ have been defined on the basis of the determined capacities Cᵢ of the cells, all of the cells are charged to their individual end-of-charge voltage CVLᵢ.

In this case, the charge quantities per cell are measured and the value of the available amount of energy in the entire energy store is determined. The initialization process is thus concluded.

In the operating process, as illustrated in FIG. 2, the individual cells are discharged and recharged on the basis of the now individually predetermined end-of-charge voltages. In the example, the cells have a matching end-of-discharge voltage DVL, but it may also be expedient for the end-of-discharge voltages DVL to be fixed individually for each cell.

FIG. 2 shows the profiles of the charge voltage, current and the state of charge SoC, i.e. in the specified example shown in Table 3 the curve profile of the strongest cell C_{MAX} corresponds to cell number 5 with an end-of-charge voltage CVL₅ of 4.2 V and the curve profile of the weakest cell C_{MIN} corresponds to cell number 4 with an end-of-charge voltage CVL₄ of 4.0 V.

By virtue of the conservation according to the invention of the weaker cells, said cells age more slowly, the cell properties harmonize more and more, the cell drift is reduced, and there is automatic matching of the cells.

As is apparent from FIG. 2, the current flow through the cells connected in series differs merely in a limited region between times t₂ and t₃ or between t₄ and t₅, i.e. in phases in which the cells are already partially discharged.

In these phases, stronger cells are loaded with increased current flow to a greater extent as well. This is achieved by suitable driving of the energy transfer units in a battery management system.

Limiting the interventions of the battery management system to regions in which the cells are already partially discharged has the effect of limiting the losses owing to the energy transfer units in a battery management system since the operating state of the extensive discharge of the cells occurs comparatively seldom since, in particular in the case of use in electric vehicles, the aim is to keep the energy store as charged as possible in order thus to allow a maximum operating range.

During charging and discharging the battery management system performs continuous load current measurements which are processed to a load profile. This profile is used for load current prediction during discharge and charge cycles. In addition to measurements, historic data is included in the calculation to achieve a most accurate approximation of the upcoming load current. Today, state-of-the-art prediction algorithm can be coupled to external prediction data from driver information systems, such as route planner and navigation systems.

In a simple configuration with limited resources a mean load current can be predicted with the principle of averaging the measured current. An adapted recursive average can be achieved with the following equation. The factor x defines the influence of the new measured value.

I_{MEAN}=I₍ₜ₋₁₎−(I₍ₜ₋₁₎/x)+(Iₜ/x)

In order to achieve accurate prediction during fast current changes and a long measurement time, the factor x is made dependent on the current state. Therefore for periods of time with no current the factor x is held to a low value. This allows quick adaptation to the new value. In all other cases the factor x is incremented to form over time a more accurate mean value.

The prediction of the load current allows the calculation of the remaining runtime to end-of-discharge voltage of the energy store. This remaining time is dependent on the remaining capacity of each battery cell and their state-of-charge. The battery cell with the least amount of energy is defining the remaining runtime of the energy store.

t_{remaining}=min(C₁·SoC₁,C₂·SoC₂,C₃·SoC₃, . . . )/I_{MEAN}

During discharging the start point t₂ for the beginning of the additional energy transfer is firstly dependent on the performance of the energy transfer units in the battery management system, i.e. on the technical implementation thereof, and secondly also on the sum of the differences in capacity of the cells in the energy store. In any case, the start point should be selected such that the maximum capacity of all of the cells is exhausted when said cells have reached their end-of-discharge voltage DVL.

The start point t₂ for the beginning of the additional energy transfer is advantageously defined as a specific state of charge of the highest capacity cell. The individual energy transfer of each cell is activated in the latest possible state-of-charge point, in order to reach their end-of-discharge voltage at the same time.

The individual start points are calculated from the energy to be transferred E_{iTransfer}, the power of transfer unit P_{iTransfer} and the transfer time t_{iTransfer} and is an iterative process. First, the capacity loss due to transfer losses results from the amount of energy to be transferred and the efficiency of each individual transfer unit per cell.

Step 1:

$${C}_{LossTransfer} = {\sum }_{i = 1}^{n} [ ( {C}_{i} - {C}_{MI N} ) \cdot ( 1 - {η}_{i} ) ]$$

The time of the transfer is relative to the mean energy of the energy store and the discharging current I_{MEAN}. However, as for real systems, the transfer losses C_{LossTransfer} must be considered for accurate start point calculation.

Step 2:

t_{transfer}=(C_{MEAN}−C_{LossTransfer})/I_{MEAN}

The power of the transfer unit can be calculated by the product of voltage and current.

Step 3:

$${P}_{iTransfer} = {\int }_{SoCiA}^{0} {A}_{iTransfer} d t \cdot {\int }_{SoCiA}^{0} {V}_{i} d t$$

If the current of the energy transfer unit is controlled to be constant, then the integral of the current can be simplified to a constant value.

The necessary energy is dependent on the capacity of the selected cell Cᵢ, the minimum capacity cell C_{MIN} of the system and the already transferred energy of the selected transfer unit C_{iFinished}.

Step 4:

$${E}_{iTransfer} = ( {C}_{i} - {C}_{MI N} - {C}_{iFinished} ) \cdot {\int }_{SoCiA}^{0} {V}_{i} d t$$

In a hardware topology other than in WO 2010/088844, i.e. a bidirectional transfer unit for individual cells, the calculation step 4 must be adapted.

Step 4:

$${E}_{iTransfer} = ( {C}_{i} - {C}_{MEAN} - {C}_{LossTransfer} - {C}_{iFinished} ) \cdot {\int }_{SoCiA}^{0} {V}_{i} d t$$

The individual start points for the energy transfer are then the quotient of transfer energy and transfer power and time.

Step 5:

SoC_{IA}=abs(E_{iTransfer}/P_{iTransfer})/t_{Transfer}

The calculation steps can be repeated in defined time periods or continuously throughout the discharge of the energy store. During discharge of the energy store, the amount of transferred capacity C_{iFinished} is counted.

In addition, for specific configurations could consider under a specific state-of-charge or voltage point close to the end-of-discharge a voltage balancing algorithm. This would allow balancing corrections caused by the imprecision of measurement or calculation. The lack of measurement and calculation accuracy can be induced by temperature change, chemical changes in the energy store or integrative errors over time. The regulation threshold of the voltage balancing algorithm is advantageously selected as half voltage between the highest voltage and the lowest voltage, whereas the energy transfer of high voltage cells is activated.

Vᵢ≧(V_{MAX}+V_{MIN})/2

Moreover the power of the energy transfer unit near the end-of-discharge voltage might be out of specification and the energy transfer might be terminated before reaching the individual or equal end-of-discharge voltage DVLᵢ.

During charging the start point of the additional energy transfer is dependent on the application and the amount of energy to be transferred. Due to the fact that the power of the energy transfer unit might be out of specification, the start point t₂ can be selected at a specific state-of-charge or voltage point.

The energy transfer is controlled to start immediately for all cells and is terminated when the amount of energy E′_{iTransfer} has been transferred. The cell individual point of energy transfer completion is defined as SoC_{IE}. In order to calculate this state-of-charge point the transfer time t′_{Transfer} and the transfer losses C′_{LossTransfer} are calculated in step 1 and 2.

Moreover the power of the energy transfer is calculated in step 3.

$${C}_{LossTransfer}^{′} = {\sum }_{i = 1}^{n} [ ( {C}_{MA X} - {C}_{i} ) \cdot ( 1 - {η}_{i} ) ]$$

$${t}_{Transfer}^{′} = ( {C}_{MEAN}^{′} - {C}_{LossTransfer}^{′} ) / {I}_{MEAN}$$

$${P}_{iTransfer}^{′} = {\int }_{0}^{SoCiE} {A}_{iTransfer} d t \cdot {\int }_{0}^{SoCiE} {V}_{i} d t$$

This amount is related to the transferred energy during discharging, the charging efficiency k of the cell and further defines the point SoC_{IE} of the individual transfer end.

Step 4:

$${E}_{iTransfer}^{′} = 1 / k \cdot ( {C}_{MA X} - {C}_{i} + {C}_{iFinished}^{′} ) \cdot {\int }_{0}^{SoCiE} {V}_{i} d t$$

The individual end points SoC_{IE} are defined by the quotient of transfer energy and transfer power and time.

Step 5:

SoC_{IE}=abs(E′_{iTransfer}/P′_{iTransfer})/t′_{Transfer}

Alternatively, the amount of energy to be transferred can be determined by accumulating the energy amount for each battery cell during discharge. The accumulated value must be reversed as the charging current from a low capacity cell must be reduced.

In an advantageous implementation of the invention, the calculation and measurement error are considered and a voltage regulation algorithm is applied to the near end-of-charge voltage. This voltage regulation performs charge corrections of the individual cells in order to reach the selected end-of-charge voltage CVLᵢ.

Cell aging brings about a change in the cell properties. This relates in particular to the cell capacity, which does not reach a relatively stable value until approximately 100 charge/discharge cycles after the cell has first been brought into operation and then constantly decreases as the age increases.

It is therefore necessary to recalibrate the control system at regular time intervals.

In this case, it is expedient to provide different calibration processes, namely a first calibration process which is performed, for example, in each case after 10-20 charge cycles and is used for calibrating essential control parameters.

For example, in this case all of the cells can be charged to their individual end-of-charge voltage CVLᵢ and the respective charge quantity meters are reset to the value determined in the initialization process. Thus, any measurement errors which are integrated by frequent charge and discharge operations are compensated for.

A second calibration process can be performed in each case after 100-200 charge cycles. In this case, complete recalibration of the system and renewed determination of the actual capacities of each individual cell, as well as of the internal resistances and other SOH parameters is performed. The second calibration process largely corresponds to the initialization process. The different properties of the individual cells in the storage arrangement which have changed as a result of aging are redetected in order to derive from these properties the bases for the further control method.

In the case of an electric vehicle, the second calibration process is required approximately once a year and can therefore be performed in the course of the standard yearly service.

The method according to the invention therefore includes constant adaptation and therefore optimization of the battery management system to the changing cell properties.

As illustrated in FIG. 3, an extension of the life of energy stores in comparison with conventional battery management approaches is therefore achieved.

The life of a rechargeable battery is defined differently in application-specific fashion. For use in electric vehicles, for example, the life is fixed as the time at which the rechargeable battery now only has 75% of its original capacity. After this, it can still be used for a few more years in other applications with less stringent requirements until the life limit for this other application is reached as well.

FIG. 3 shows the ratio of the capacity of cells to their rated capacity C/C_{N} over time in each case for the strongest cell C_{MAX1}, C_{MAX2}, C_{MAX3} and the weakest cell C_{MIN1}, C_{MIN2}, C_{MIN3} in an arrangement with passive balancing C_{MAX3}, C_{MIN3}, an arrangement with active balancing C_{MAX2}, C_{MIN2}, and an arrangement which is controlled by the method according to the invention C_{MAX1}, C_{MIN1}. The characteristics show that, in the conventional balancing methods, the respectively weakest cells age more quickly than the strongest cells, the curve profiles of the capacity ratios C/CN of the weaker cells C_{MIN2}, C_{MIN3} fall away more quickly than the strongest cells, corresponding to curve profiles C_{MAX2}, C_{MAX3}. Since, however, the life of the entire storage arrangement is determined by the respective weakest cell, this rapid aging process also results in a shorter life of the storage arrangement.

In contrast, when using the method according to the invention, the aging processes of the cells C_{MIN1}, C_{MAX1} harmonize with one another, whereby an extension of the life of the storage arrangement is achieved.

FIG. 3 shows the respective end of life 1, 2, 3 by virtue of the point of intersection of the curve profiles of the capacity ratios C/CN of the weaker cells C_{MIN1}, C_{MIN2}, C_{MIN3} with the 75% value LG.

The exemplary energy storage arrangement shown in FIG. 4 for implementing the method according to the invention comprises storage cells C1, C2, C3, . . . CN, connected in series.

Each storage cell C1, C2, C3, . . . CN is connected in parallel with an energy transfer unit ET1, ET2, ET3, . . . ETn. The energy transfer units are controlled by a central control unit SE.

The energy storage arrangement depicted can be combined, as a battery module (rechargeable battery pack) with further battery modules by being connected in series to form high-voltage energy stores. In this case, it is expedient if the control unit SE comprises, in addition to the control electronics, means for energy transfer to other battery modules. It is then possible to construct large energy stores by cascading battery modules.

### LIST OF REFERENCE SYMBOLS

V Voltage
I Current
CVL End-of-charge voltage
CVL_{MAX} End-of-charge voltage of strongest cell
CVL_{MIN} End-of-charge voltage of weakest cell
CVLᵢ End-of-charge voltage of cell No. i
SoC State of charge
DVL End-of-discharge voltage
t1, t2 . . . t7 Notable times in the operating process
C_{MAX1}, C_{MAX2}, C_{MAX3} Capacity of the strongest cell in a storage arrangement
C_{MIN1}, C_{MIN2}, C_{MIN3} Capacity of the weakest cell in a storage arrangement
1 End of life of an arrangement with the method according to the invention
2 End of life of an arrangement with the conventional active balancing method
3 End of life of an arrangement with the conventional passive balancing method
C₁, C₂, C₃, . . . C_{N} Storage cells
ET₁, ET₂, ET₃, . . . ETₙ Energy transfer units
SE Control unit

1. A method for operating an energy storage arrangement with a plurality of serially connected storage cells, comprising the following steps:
S1: Calculating the amount of energy to be transferred so that all cells reach a predetermined state-of-charge and calculating the energy losses in the energy transfer units,
S2: Determining the load profile and calculating the remaining time (t_{Transfer}, t′_{Transfer}) until the energy storage arrangement reaches the predetermined state-of-charge,
S3: Calculating the energy transfer unit's power capability (P_{iTransfer}, P′_{iTransfer}) at the selected range of operation,
S4: Calculating the amount of energy to be transferred from/to each individual cell (E_{iTransfer}, E_{iTransfer}), and
S5: Calculating the individual state-of-charge (SoC_{iA}, SoC_{iE}) point for each cell at which the energy transfer among individual cells must be activated to reach predetermined individual state-of-charge at the same time.

2. The method of claim 1, wherein the calculation of the individual state-of-charge (SoC_{iA}, SoC_{iE}) in S5 is defined as an open-circuit voltage (V_{iA} or V_{iE}).

3. The method of claim 1, wherein the energy transfer during discharging is completed before reaching the end-of-discharge voltage (DVL).

4. The method of claim 1, wherein the energy transfer during charging is performed according to S4 and S5 after a predetermined state-of-charge (SoC_{iA}, SoC_{iE}), preferably near the end-of-discharge voltage (DVL), is exceeded.

5. The method of claim 1, wherein the energy transfer during charging is performed according to S4 and S5 after a predetermined state-of-charge is exceeded.

6. The method of claim 1, wherein the predetermined individual state-of-charge is an equal predetermined state-of-charge for all cells.

7. The method of claim 1, wherein the predetermined individual state-of-charge is when the end-of-charge voltage (CVL) or the end-of-discharge voltage (DVL) is reached.
